(19) United States
(12) Patent Application Publication
(10) Pub. No.: US 2016/0336160 A1
(43) Pub. Date: Nov. 17, 2016

(54) Ion Guide for Mass Spectrometry

(71) Applicant: DH TECHNOLOGIES DEVELOPMENT PTE. LTD., Singapore (SG)

(72) Inventor: Takashi Baba, Richmond Hill (CA)

(21) Appl. No.: 15/106,865

(22) PCT Filed: Nov. 18, 2014
(86) PCT No.: PCT/IB2014/002495

§ 371 Date: Jun. 21, 2016

Related U.S. Application Data
(60) Provisional application No. 61/922,319, filed on Dec. 31, 2013.

(51) Int. Cl. H01J 49/06

(52) U.S. Cl. CPC H01J 49/062

(57) ABSTRACT

Methods and systems for transmitting ions in an ion guide are provided herein. In accordance with various aspects of the applicant's teachings, the methods and systems can cause at least a portion of ions entrained in a gas flow entering an ion guide to be extracted from the gas jet and be guided downstream along one or more path of gas flow, where the gas lacking the ions can be removed from the ion guide. In some embodiments, the ions extracted from the gas stream can be guided into a focusing region in which the ions can be focused, e.g., via RF focusing, to enter into subsequence processing stages, such as a mass analyzer.

### RELATED APPLICATION

This application claims priority to U.S. provisional application No. 61/922,319, filed on Dec. 31, 2013, which is incorporated herein by reference in its entirety.

### FIELD

The teachings herein relate to methods and apparatus for mass spectrometry, and more particularly to ion guides and methods for transporting ions.

### INTRODUCTION

Mass spectrometry (MS) is an analytical technique for determining the elemental molecules of sample substances with both quantitative and qualitative applications. For example, MS can be useful for identifying unknown compounds, determining the isotopic composition of elements in a molecule, and determining the structure of a particular compound by observing its fragmentation, as well as for quantifying the amount of a particular compound in the sample.

In mass spectrometry, sample molecules are generally converted into ions using an ion source and then separated and detected by one or more downstream mass analyzers. For most atmospheric pressure ion sources, ions pass through an inlet orifice prior to entering an ion guide disposed in a vacuum chamber. A radio frequency (RF) voltage applied to the ion guide can provide radial focusing as the ions are transported into a subsequent, lower-pressure vacuum chamber in which the mass analyzer(s) are disposed. Though increasing the size of the inlet orifice between the ion source and ion guide can increase the number of ions entering the ion guide (which can offset ion losses and potentially increase the sensitivity of downstream detection), higher pressures in the first stage vacuum chamber from the increased gas flow can reduce the ability of the ion guide to focus the ions as a result of increased collisions with ambient gas molecules.

Accordingly, there remains a need for mass spectrometer systems and methods for maximizing the number of ions entering the ion guide while maintaining the ion transfer efficiency to downstream analyzers to attain high sensitivity.

### SUMMARY

In accordance with one aspect, certain embodiments of the applicant's teaching relate to an ion guide comprising an enclosure comprising at least two opposed sidewalls extending longitudinally along a central axis from a proximal inlet end to a distal outlet end, the proximal inlet end being configured to receive a plurality of ions entrained in a gas flow through an inlet orifice disposed on the central axis; and an obstruction disposed within said enclosure between the proximal and distal ends, said obstruction deflecting at least a portion of the gas flow away from said central axis of the enclosure. In accordance with various aspects of the present teachings, each of said opposed sidewalls comprises a plurality of electrodes to which RF and DC electric potentials are applied so as to generate an electric field for deflecting said entrained ions away from the central axis of the enclosure proximal to said obstruction and at least one electrode to which a RF electric potential is applied for focusing said deflected ions toward the central axis distal to said obstruction. In some aspects, the distal outlet end can be configured to transmit the focused ions through an outlet orifice to a downstream mass analyzer.

The opposed sidewalls can have a variety of configurations. For example, in one aspect, at least one of the opposed sidewalls defines a window through which the gas flow can exit the enclosure. For example, the obstruction (e.g., disposed on the central axis) can be configured to deflect at least a portion of the gas flow to windows defined in each of the opposed sidewalls.

In various aspects, the enclosure can be further defined by opposed wall electrodes disposed between the opposed sidewalls. For example, the opposed wall electrodes can extend along at least a portion of the length of the opposed sidewalls. In some aspects, the opposed wall electrodes can be coupled to a power source for applying an RF signal to the opposed wall electrodes. In one aspect, the opposed wall electrodes are offset relative to the central axis such that they are outside the gas flow. Additionally, in some aspects, a distance between the opposed wall electrodes can vary along at least a portion of their length. For example, an inner surface of the opposed wall electrodes can be non-parallel with the central axis along at least a portion of their length along the central axis.

The plurality of electrodes of the opposed sidewalls can have a variety of configurations. For example, the plurality of electrodes can comprise a plurality of polygonal conductive surfaces. For example, at least one of the polygonal conductive surfaces can be substantially triangular, quadrilateral, pentagonal, hexagonal, heptagonal, or pentagonal, all by way of non-limiting example. In related aspects, opposed sides of at least one of the polygonal conductive surfaces can be non-parallel. In other related aspects, adjacent sides of at least one of the polygonal conductive surface can be non-perpendicular.

In various aspects, at least one of the plurality electrodes can be asymmetrical along two axes. For example, at least one of the plurality electrodes can be non-rectangular.

In some aspects, the plurality of electrodes can comprise substantially planar conductive surfaces. In various aspects, the opposed sidewalls comprise printed circuit boards extending along a longitudinal axis from a proximal end to a distal end. For example, the plurality of electrodes can comprise conductive surfaces separated from adjacent electrodes by non-conductive portions of the printed circuit boards. In some aspects, at least some of the non-conductive portions are not perpendicular to one another. In one aspect, at least some of the non-conductive portions are not parallel or perpendicular to the longitudinal axis of the printed circuit board.

In one aspect, the opposed sidewalls further comprise a plurality of electrodes to which only an RF signal is applied.

In some aspects, the DC electric potential applied has the same polarity as one or more ions of interest so as to cause deflection of the ions of interest away from the central axis.

In some aspects, the plurality of electrodes can be configured to define a potential minimum (e.g., for the ions of interest) substantially outside of said gas flow.

In various aspects, an electric field at the inlet end and outlet end are substantially quadrupole or multipole RF fields. By way of example, the ion guide can comprise a plurality of rods at the inlet end configured to generate a multipole RF focusing field. In one aspect, the RF signals applied to pairs of opposed inlet rods can be different phases from each other.

In various aspects, the ion guide can further comprise a plurality of rods at the outlet end configured to generate a quadrupole or multipole RF focusing field.

In some aspects, the enclosure can be maintained at a vacuum pressure in a range of about 1 to about 20 Torr.

In accordance with one aspect, certain embodiments of the applicants' teachings relate to a method for transmitting ions. According to the method, a plurality of ions entrained in a gas flow is received at an inlet end of an enclosure, said enclosure extending longitudinally around a central axis from the proximal inlet end to a distal outlet end, said enclosure comprising at least two opposed sidewalls extending longitudinally along the central axis with each of the opposed sidewalls having a plurality of electrodes. The method can also include applying RF and DC electric voltages to at least an opposed pair of the plurality of electrodes of the opposed sidewalls so as to generate an electric field in the enclosure for deflecting at least a portion of said entrained ions away from the central axis, deflecting at least a portion of the gas flow to an opening for exiting the enclosure subsequent to deflecting said deflected ions, and focusing said deflected ions for transmission to a downstream mass analyzer.

In some aspects, at least one of the opposed sidewalls defines a window through which at least a portion of the gas flow is removed from the enclosure.

In various embodiments, the enclosure is further defined by opposed wall electrodes disposed between the opposed sidewalls, wherein the opposed wall electrodes are offset relative to said central axis such that they are outside the gas flow. In some aspects, the ion guide defines a potential minimum substantially along the opposed wall electrodes but separated therefrom by a small distance (e.g., about 1-3 mm) so as to draw ions of interest thereto.

In accordance with one aspect, certain embodiments of the applicants' teachings relate to a mass spectrometer system that comprises an ion source, a proximal, inlet plate having an inlet aperture configured to receive a plurality of ions entrained in a gas flow from the ion source, and a distal, outlet plate having an outlet aperture configured to transmit a plurality of ions to a mass analyzer. In various aspects, an ion guide can be disposed between the inlet plate and the outlet plate, and the ion guide can include an enclosure comprising at least two opposed sidewalls extending longitudinally along a central axis from a proximal inlet end to a distal outlet end, the proximal inlet end being configured to receive the gas flow and entrained ions from the inlet aperture. An obstruction is disposed within said enclosure for deflecting at least a portion of the gas flow away from said central axis of the enclosure, wherein said opposed sidewalls comprise a plurality of opposed conductive regions to which RF and DC electric voltages are applied so as to generate an electric field for deflecting said entrained ions away from the central axis of the enclosure proximal to said obstruction and at least one opposed conductive region to which an RF electric voltages is applied for focusing said deflected ions toward the central axis distal to said obstruction.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1, in schematic diagram, depicts an exemplary mass spectrometer system comprising an ion guide in accordance with one aspect of various embodiments of the applicant's teachings.

FIG. 2 depicts a perspective view of the exemplary ion guide of FIG. 1.

FIG. 3, in schematic diagram, depicts an exemplary PCB sidewall for use in the ion guide of FIG. 1, the PCB sidewall comprising a plurality of electrodes arranged in accordance with various aspects of the applicant's teachings.

FIG. 4 schematically depicts exemplary potentials applied to an ion guide in accordance with various aspects, the ion guide comprising a PCB sidewall as shown in FIG. 3.

FIG. 5 schematically depicts the exemplary forces experienced by a cation while traversing the ion guide of FIG. 1, having the exemplary potentials of FIG. 4 applied to the PCB sidewalls.

FIG. 6 depicts a simulated path for ions of various m/z ratios transmitted through the ion guide of FIG. 1, having the exemplary potentials of FIG. 4 applied to the PCB sidewalls.

FIG. 7, in schematic diagram, depicts another exemplary PCB sidewall for use in an ion guide in accordance with one aspect of various embodiments of the applicant's teachings.

FIG. 8 schematically depicts exemplary potentials applied to an exemplary ion guide utilizing the PCB sidewall shown in FIG. 7.

FIG. 9 schematically depicts the exemplary forces experienced by a cation while traversing the ion guide depicted in FIG. 8.

FIG. 10 depicts exemplary data of ion transmission utilizing a prototype ion guide in accordance with FIG. 8.

FIG. 11, in schematic diagram, depicts another exemplary PCB sidewall for use in an ion guide in accordance with one aspect of various embodiments of the applicant's teachings.

FIG. 12 schematically depicts exemplary potentials applied to an exemplary ion guide utilizing the PCB sidewall shown in FIG. 11.

FIG. 13 schematically depicts the exemplary forces experienced by a cation while traversing the ion guide of FIG. 12.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

Methods and systems for transmitting ions in an ion guide are provided herein. In accordance with various aspects of the applicant's teachings, the methods and systems can cause at least a portion of ions entrained in a gas flow entering an ion guide to be extracted from the gas jet and be guided downstream along one or more paths separate from the path of gas flow (the gas lacking the ions can be removed from the ion guide). In some embodiments, the ions extracted from the gas stream can be guided into a focusing region in which the ions can be focused, e.g., via RF focusing, to enter into subsequent processing stages, such as a mass analyzer.

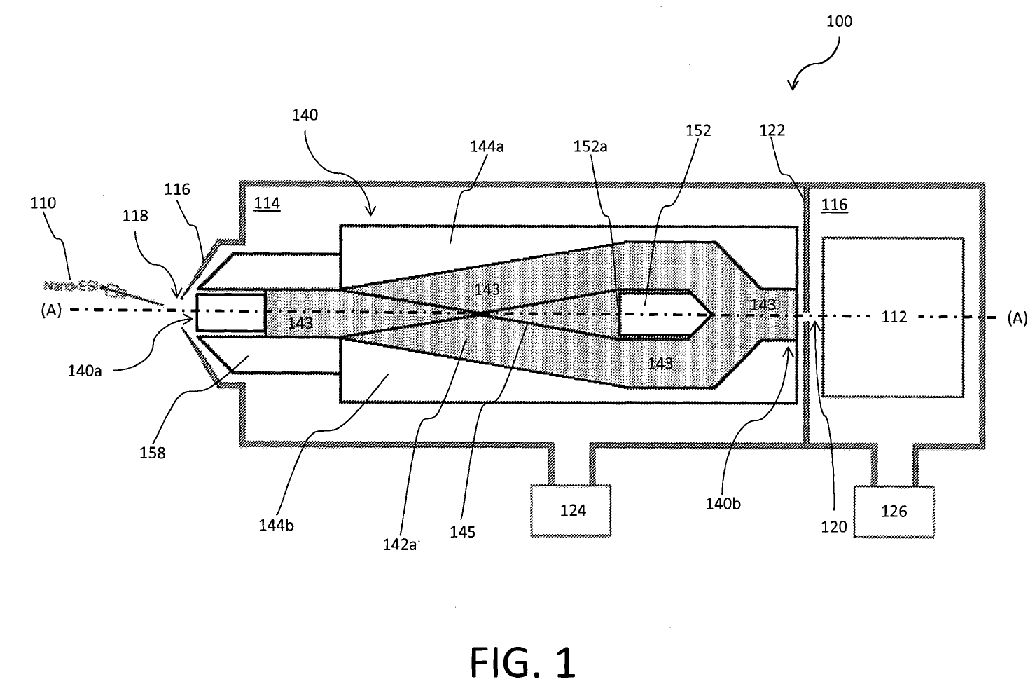

With reference now to FIG. 1, an exemplary mass spectrometry system 100 in accordance with various aspects of applicant's teachings is illustrated schematically. As will be appreciated by a person skilled in the art, the mass spectrometry system 100 represents only one possible configuration in accordance with various aspects of the systems, devices, and methods described herein. As shown in FIG. 1, the exemplary mass spectrometry system 100 generally comprises an ion source 110 for generating ions from a sample of interest, an ion guide 140, and an ion processing device (herein generally designated mass analyzer 112).

Though only mass analyzer 112 is shown, a person skilled in the art will appreciate that the mass spectrometry system 100 can include additional mass analyzer elements downstream from the ion guide 140. As such, ions transmitted through the vacuum chamber 114 containing the ion guide 140 can be transported through one or more additional differentially pumped vacuum stages containing one or more mass analyzer elements. For instance, in some aspects, a triple quadrupole mass spectrometer may comprise three differentially pumped vacuum stages, including a first stage maintained at a pressure of approximately 2.3 Torr, a second stage maintained at a pressure of approximately 6 mTorr, and a third stage maintained at a pressure of approximately 10⁻⁵ Torr. The third vacuum stage can contain, for example, a detector, as well as two quadrupole mass analyzers (e.g., Q1 and Q3) with a collision cell (Q2) located between them. It will be apparent to those skilled in the art that there may be a number of other ion optical elements in the system. This example is not meant to be limiting as it will also be apparent to those of skill in the art that the ion guide described herein can be applicable to many mass spectrometer systems that sample ions at elevated pressures. These can include time of flight (TOF), ion trap, quadrupole, or other mass analyzers, as known in the art.

Moreover, though the ion source 110 of FIG. 1 is depicted as an electrospray ionization (ESI) source, a person skilled in the art will appreciate that the ion source 110 can be virtually any ion source known in the art, including for example, a continuous ion source, a pulsed ion source, an electrospray ionization (ESI) source, an atmospheric pressure chemical ionization (APCI) source, an inductively coupled plasma (ICP) ion source, a matrix-assisted laser desorption/ionization (MALDI) ion source, a glow discharge ion source, an electron impact ion source, a chemical ionization source, or a photoionization ion source, among others. By way of non-limiting example, the sample can additionally be subjected to automated or in-line sample preparation including liquid chromatographic separation.

As shown in FIG. 1, the ion guide 140 can be contained within a vacuum chamber 114. In various aspects, the vacuum chamber 114 includes an orifice plate 116 having an inlet orifice 118 for receiving ions from the ion source 110. The vacuum chamber 114 can additionally include an exit aperture 120 in an exit lens 122 through which ions transmitted by the ion guide 140 can be transferred to a downstream vacuum chamber 116, which houses, for example, one or more ion processing devices (e.g., mass analyzer 112). As will be appreciated by a person skilled in the art, the vacuum chambers 114, 116 can be evacuated to sub-atmospheric pressure as is known in the art. By way of example, mechanical pumps 124, 126 (e.g., turbo-molecular pumps, rotary pumps) can be used to evacuate the vacuum chambers 114, 116, respectively, to appropriate pressures.

In various aspects, ions generated by the ion source 110 are transmitted into the vacuum chamber 114 and can be entrained in a supersonic flow of gas as the gas entering the vacuum chamber expands through the inlet orifice 118. This phenomena, typically referred to as supersonic free jet expansion as described, for example, in U.S. Pat. Nos. 7,256,395 and 7,259,371 (each of which is hereby incorporated by reference in its entirety), aids in axially transporting the entrained ions through the vacuum chamber 114. Prior art ion guides that rely solely on radial RF focusing to transmit the ions entrained in the gas flow into downstream analyzers, however, can experience difficulty in focusing ions in higher pressure environments due to the ions' collision with ambient gas molecules within the supersonic gas flow. As such, prior art systems generally limit, for example, the size of the inlet orifice 118 so as to maintain the gas flow and pressure within the vacuum chamber at a level such that the entrained ions can still be focused into a narrow beam for transmission into a subsequent chamber for downstream processing.

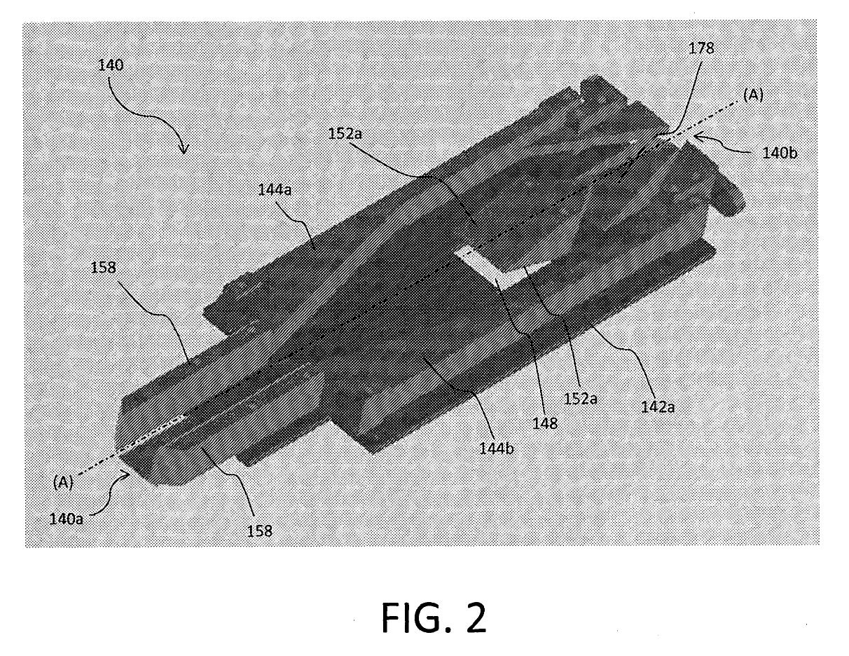

In accordance with various aspects of the applicant's present teachings, the ion guide 140 extends from an inlet end 140a to an outlet end 140b and generally defines an enclosure through which the ions pass prior to exiting vacuum chamber 114 through the outlet orifice 120. The ion guide 140 receives at its inlet end 140a ions entrained within the gas flowing through the inlet orifice 118 along a longitudinal, central axis (A) of the ion guide 140. For example, as shown in FIGS. 1 and 2, the inlet end 140a can comprise a plurality of inlet rods 158 disposed around the central axis (A) so as to provide a radially-directed force to the ions within the gas stream. Though as discussed above the ions' collision with the molecules within the gas stream in this region of the ion guide 140 may prevent the ions from being focused into a coherent ion beam, an RF signal applied to the inlet rods 158 can be sufficient to generate a quadrupole RF field that maintains the ions substantially along the central axis to prevent the ions from initially being lost against the walls of the ion guide 140 upon entry.

After traversing the inlet rods 158 of the ion guide 140, the ions (and the gas stream) enter a portion of the enclosure substantially bounded by a plurality of conductive elements to which electric potentials can be applied for extracting (e.g., separating) at least a portion of the ions from the gas stream. For example, in various aspects, the ion guide 140 can be configured to displace the ions entering the ion guide 140 out of the gas flow and/or away from the central axis (A). By way of example, the mean radial position of an ion as it is transmitted through the ion guide 140 can be offset from the central axis (A). As shown in FIGS. 1 and 2, the enclosure can be bounded by two, substantially planar sidewalls 142 extending along opposed sides of the central axis (A) (for purposes of clarity, only the “left” opposed sidewall 142a is depicted), and by top and bottom opposed electrodes 144a,b (hereafter “wall electrodes 144”) that extend between the opposed sidewalls 142a,b at least partially along the length of the ion guide 140.

In the depicted exemplary embodiment, for example, the opposed planar sidewalls 142 can comprise printed circuit boards (PCBs), with each defining a plurality of substantially planar electrodes 143 separated by non-conductive portions 145. As discussed in detail below, RF and/or DC voltages can be applied to the various conductive portions of the opposed sidewalls 142 and the wall electrodes 144 for controlling the movement of ions through the ion guide 140 (e.g., the movement of the ions relative to the central axis (A)). Moreover, the configuration (e.g., shape/size/position) of the various electrode(s) 143 of the opposed sidewalls 142 (and the electric potentials applied thereto) can be selected in accordance with the present teachings to control the radial deviation of the ions as they traverse the ion guide 140 under the influence of the axial momentum initially imparted to the ions by the gas flow.

It should be appreciated that the terms “left” and “right” as applied to the sidewalls 142 and “top” and “bottom” as applied to the wall electrodes 144 are merely used to demonstrate various portions of the ion guide 140 and their operation, but should not be construed as limiting the particular configuration of ion guides in accordance with the present teachings. By way of example, it should be appreciated that the substantially planar sidewalls 142a,b could instead be disposed above and below the central axis (A) of the ion guide 140, while the opposed wall electrodes 144 are on left and right sides of the central axis. Moreover, it will be appreciated that though the wall electrodes 144 are said to be extending between the opposed sidewalls 142a,b, it is not necessary that the sidewalls and electrodes are coupled (e.g., sealed) to one another. Rather, the enclosure said to be “bound” by the sidewalls and electrodes can comprise a volume within which the trajectory of the ions are generally bound.

Moreover, though the space bounded by the substantially planar sidewalls 142a,b and opposed wall electrodes 144 can be axially aligned with the space defined by inlet rods 158, the maximum “height” of the space defined by the planar sidewalls 142a,b and opposed wall electrodes 144 (i.e., the distance between the opposed wall electrodes 144 in FIGS. 1 and 2) can be greater than the distance between the corresponding opposed inlet rods 158. As will be appreciated by a person skilled in the art, upon entering the inlet orifice 118, gas undergoing free jet expansion will slow down and recompresses to form what is commonly referred to as a Mach disk. After recompressing, the radial boundaries of the gas flow are generally defined by a barrel shock structure. In accordance with various aspects of the present teachings, the distance between the opposed inlet electrodes 158 (and indeed the distance between the planar sidewalls 142a,b) can be configured to substantially accommodate the radial boundaries of this barrel shock structure, while the “height” of the enclosure (i.e., the distance between the opposed wall electrodes 144) provides additional space for the ions to be moved out of the barrel shock structure and toward one or more of the wall electrodes 144 under the influence of the electric potentials applied to various portions of the ion guide 140 as the gas stream and ions traverse therethrough.

Continuing downstream (left to right in FIG. 1), the ion guide 140 also comprises an obstruction 152 for deflecting the gas flow out of the ion guide 140 after at least a portion of the ions (e.g., at least a substantial portion of ions, 80%) have been extracted out of the gas stream. The obstruction 152 can have a variety of configurations for deflecting the gas stream, but as shown in the exemplary ion guide 140 of FIGS. 1 and 2, it comprises at least one upstream planar surface 152a disposed on the central axis (A) such that the gas flow collides with the surface(s) 152a and is directed toward a pre-determined portion of the enclosure. For example, the surface(s) 152a can be angled relative to the major axis of gas flow such that gas deflected therefrom is substantially directed out of the ion guide 140 (e.g., via an exit window 148 formed in at least one of the opposed planar sidewalls 142 and the wall electrodes 144). As best seen in FIG. 2, for example, the obstruction 152 can comprise two planar surfaces 152a extending downstream from an apex on the central axis (A) such that the gas flow is split to be directed to two exit windows 148 (only one of which is shown). It will also be appreciated in light of the present teachings that various molecules that are entrained within the gas stream (e.g., large and/or neutral molecules, droplets of solvent that fail to desolve in the ionization chamber) can collide with the obstruction 152 and/or be directed out of the enclosure with the gas stream, thereby preventing their transmission deeper into the mass spectrometer system 100 and helping to prevent fouling of downstream elements.

With the gas stream being directed out of the enclosure at the obstruction 152, the ions that were extracted from the gas stream can then be re-focused (e.g., deflected toward the central axis (A)) for transmission at the outlet end 140b of the enclosure through the exit aperture 120 of the lens 122. By removing at least a portion of the gas flow from the enclosure, the ions deflected around the obstruction 152 can be more easily focused (e.g., via an RF quadrupole) due to the reduced potential for collisions of ions with ambient gas molecules of the gas stream. For example, the distance between the wall electrodes 144 can decrease on their downstream ends to promote the deflection of the ions back to the central axis (A) after passing the obstruction 152, as discussed otherwise herein. Moreover, as best seen in FIG. 2, the ion guide 140 can additionally include outlet electrodes .178 disposed downstream of the obstruction 152 to aid in refocusing the ions into a coherent ion beam to be transmitted through the exit aperture 120 and into the mass analyzer 112.

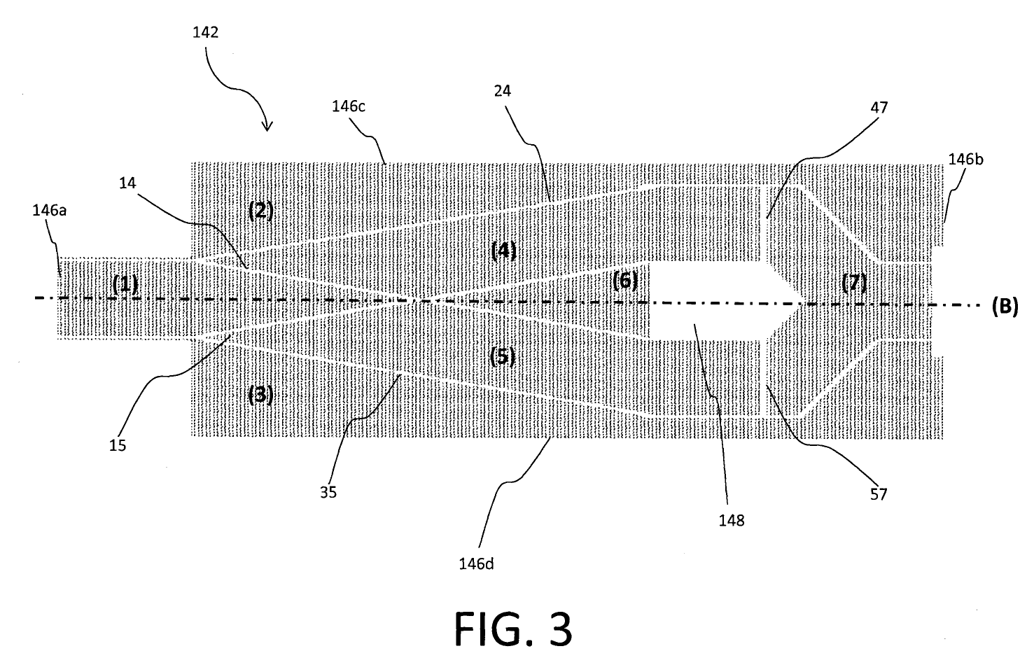

With reference now to FIG. 3, an exemplary PCB sidewall 142 in accordance with various aspects of the present teachings is schematically depicted. As shown in FIG. 3, the exemplary PCB sidewall 142 comprises a substantially planar surface extending along a longitudinal axis (B) from a proximal, inlet end 146a to a distal, outlet end 146b. Also as shown, the PCB sidewall 142 defines a window 148 through which at least a portion of the gas jet can be deflected as discussed otherwise herein. As will be appreciated by a person skilled in the art in light of the present teachings, portions of the inner surface of each PCB sidewall 142 (i.e., the surface facing the chamber through which ions are transmitted) can comprise a conductive material to which an RF and/or DC potential can be applied. By way of non-limiting example, the conductive portions can comprise copper, silver, or gold. In accordance with various aspects of the present teachings, various portions of the conductive surface can be separated by non-conductive portions such that conductive portions of the surface are electrically isolated from one another. For example, as shown in FIG. 3, the non-conductive portions can be configured to divide the PCB sidewall 142 into seven distinct regions, to which a distinct electric potential can be applied, thereby forming seven substantially planar electrodes, though more or fewer regions may be defined by the PCB sidewall 142 in accordance with the present teachings.

In accordance with the teachings herein, the conductive portions or electrodes can have a variety of configurations and can be arranged in a variety of patterns for controlling the movement of ions through the ion guide 140 as otherwise discusses herein. By way of example, the electrodes that form the sidewalls 142 can comprise a plurality of polygons having the same or different shapes as one another. By way of example, the electrodes can be substantially triangular (e.g., electrode (6) of FIG. 3), quadrilateral, pentagonal (e.g., electrode (1)), hexagonal (e.g., electrode (4)), heptagonal (e.g., electrode (3)), or even more sides (e.g., electrode (8)), all by way of non-limiting example. Moreover, the plurality of electrodes can include one or more electrodes having non-parallel, opposed sides (e.g., edge 146d and non-conductive portion 35 are not parallel), one or more electrodes having adjacent sides extending at non-right angles (e.g., at apex of electrode (1)), and one or more electrodes exhibiting asymmetry along two axes (e.g., electrode (5)). For example, as shown in FIG. 3, none of the depicted exemplary electrodes is square or rectangular. Likewise, at least some of the non-conductive portions can intersect at non-right angles (e.g., non-conductive portions 14, 15) and/or are not parallel or perpendicular to the longitudinal axis (B).

Though each of the electrode regions of the PCB sidewall 142 will now be discussed in detail with reference to FIG. 3, it is within the spirit of the present disclosure that the configuration (e.g., pattern, size, shape) of the conductive regions can be modified in accordance with the present teachings to enable extraction of ions from the gas jet, diversion of the gas jet from the enclosure at least partially defined by the PCB sidewall 142, and/or re-focusing of the ions for transmission to a downstream mass analyzer. As shown in FIG. 3, in some aspects, the inlet end 146a of the PCB sidewall can have a reduced width relative to the remainder of the PCB sidewall 142 and can be configured to form, in conjunction with the inlet rods 158 as described above with reference to FIGS. 1 and 2, an upstream focusing region for receiving the gas jet from the inlet orifice 118. Electrode (1) extends from the inlet end 146a toward the outlet end 146b along the longitudinal axis (B) of the PCB sidewall 142 and can be centered along the central axis (A) of the ion guide 140 as shown in FIG. 1. As discussed above, the increased “height” of the enclosure distal to the inlet rods 158 (i.e., the distance between the wall electrodes 144 of FIG. 1) relative to the distance between the inlet rods .158 can provide additional space for the ions to be moved out of the barrel shock structure and toward at least one of the wall electrodes 144. Accordingly, at the distal end of the inlet rods 158, the PCB sidewall can widen (e.g., extend substantially perpendicular to the longitudinal axis (B) of the PCB sidewall 142), thereby defining the proximal edge of electrodes (2) and (3). Electrode (1) therefore extends distally from the inlet end 146a of the PCB sidewall 142 and continues distally beyond the proximal edge of electrodes (2) and (3), though the width of electrode (1) linearly decreases as the electrode (1) extends distally until terminating on the longitudinal axis (B). Two non-conductive portions 14,24 extend from the junction of electrode (1) and electrode (2)—one non-conductive portion 24 at an upward, non-perpendicular angle relative to the longitudinal axis (B) of the PCB sidewall 142 and one non-conductive portion 14 at a downward, non-perpendicular angle relative to the longitudinal axis (B) of the PCB sidewall 142. The upward extending non-conductive portion 24 extends upward along the majority of the length of the PCB sidewall 142, becomes parallel to the longitudinal axis (B) of the PCB sidewall along the length of the window 148, and then sharply turns back toward the longitudinal axis (B) before again becoming parallel to the longitudinal axis (B) prior to the outlet end 146b of the PCB sidewall 142. The upper and lower edge of electrode (2) is thus defined by the upper edge 146c of the PCB sidewall 142 and the non-conductive portion 24, respectively, and terminates in a distal edge defined by the distal end 146b of the PCB sidewall 142.

Likewise, two non-conductive portions 15,35 extend from the junction of electrode (1) and electrode (3)—one non-conductive portion 35 at an downward, non-perpendicular angle relative to the longitudinal axis (B) of the PCB sidewall 142 and one non-conductive portion 15 at a upward, non-perpendicular angle relative to the longitudinal axis (B) of the PCB sidewall 142.

Electrode (3) represents a mirror image of electrode (2) about the longitudinal axis (B) of the PCB sidewall 142 such that the upper and lower edge of electrode (3) is defined by the non-conductive portion 35 initially extending downward from the junction of electrode (1) and electrode (3) and by the lower edge 146d of the PCB sidewall 142, respectively, and terminates in a distal edge defined by the distal end 146b of the PCB sidewall 142.

The non-conductive portion 14 extending from the junction of electrode (1) and (2) at a downward, non-perpendicular angle extends to the lower, proximal corner of the window 148, while the non-conductive portion 15 extending from the junction of electrode (1) and (3) at an upward, non-perpendicular angle extends to the upper, proximal corner of the window 148. These downward and upward extending non-conductive portions 14, 15 intersect each other at the longitudinal axis (B) of the PCB sidewall 142, thereby defining the distal end of electrode (1), and the proximal apex of electrode (6), which extends between the non-conductive portions 14, 15 along the longitudinal axis (B) of the PCB sidewall 142 to the proximal edge of window 148.

Electrode (4) extends from the junction of electrode (1) and electrode (2) and is bounded by the initially upward extending non-conductive portion 24 on its upper edge and on its lower edge by the downward extending non-conductive portion 14, then by the upward extending non-conductive portion 15 extending from the intersection of non-conductive portions 14, 15, and finally by the upper edge of the window 148.

Electrode (5) represents a mirror image of electrode (4) about the longitudinal axis (B) of the PCB sidewall 142 such that electrode (5) extends from the junction of electrode (1) and electrode (3) and is bounded by the initially downward extending non-conductive portion 35 on its lower edge and on its upper edge by the upward extending non-conductive portion 15, then by the downward extending non-conductive portion 14 from the intersection of non-conductive portions 14, 15, and finally by the lower edge of the window 148.

Electrodes (4) and (5) terminate distally in non-conductive portions 47, 57, which extend substantially perpendicular relative to the longitudinal axis (B) of the PCB sidewall 142 between the non-conductive portion 24 at the lower edge of electrode (2) and the non-conductive portion 35 at the upper edge of electrode (3), respectively. Along with the substantially perpendicular non-conductive portions 47, 57, the distal edge of the window 148 defines the proximal edge of the Y-shaped electrode (7), which extends downstream to the distal end 146b of the PCB sidewall 142 between electrodes (2) and (3).

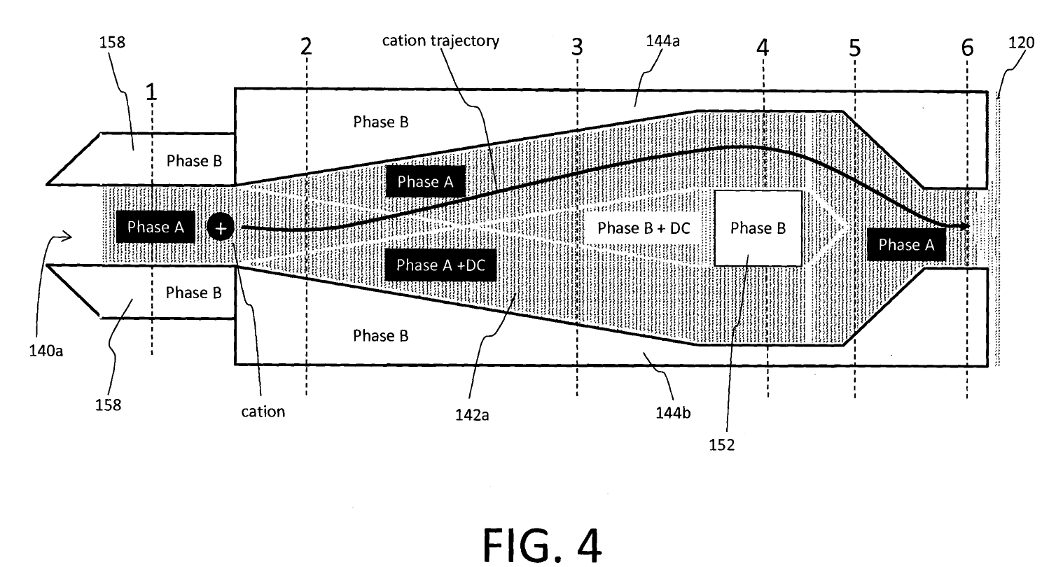

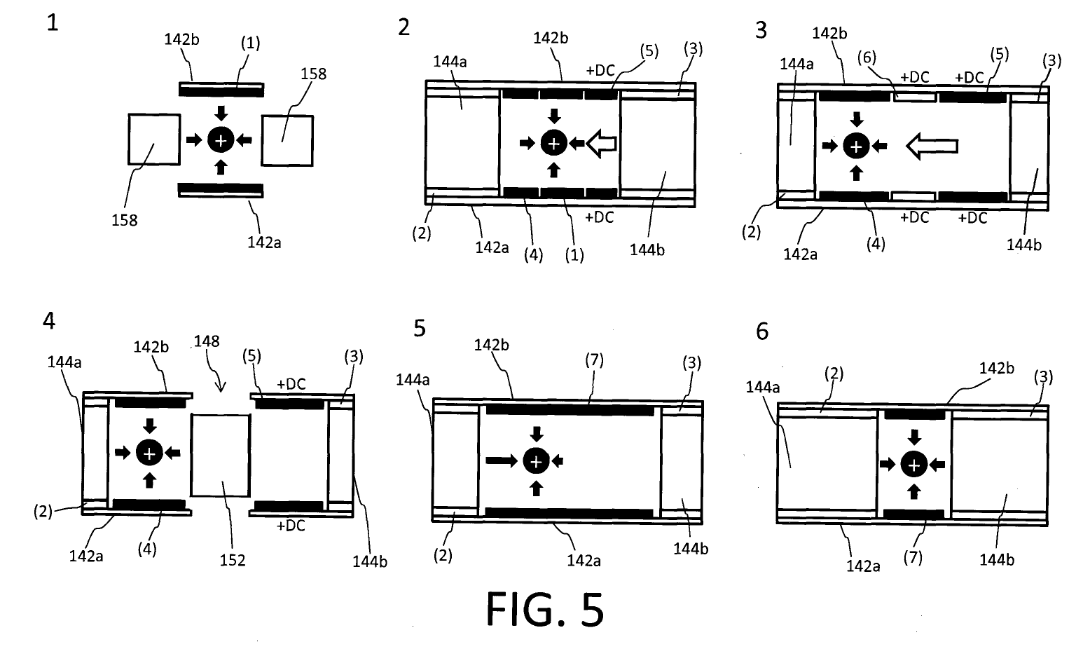

With reference now to FIGS. 4 and 5, the various elements of the ion guide 140 can have electric potentials applied thereto so as to control the movement of the ions through the ion guide in accordance with the teachings herein. By way of example, the inlet rods 158, the various regions of the opposed PCB sidewalls 142a,b, and/or the top and bottom opposed wall electrodes 144a,b can have a pattern of diverse electric potentials applied thereto so as to generate an electric field configured to extract ions from the gas jet entering the inlet orifice 118 and guide the ions downstream along one or more paths separate from the path of gas flow. In various aspects, the gas jet lacking the extracted ions can then be removed from the ion guide 140 such that the extracted ions can then be focused, e.g., via RF focusing, into a coherent ion beam for transfer into the downstream mass analyzer 112.

As shown in FIG. 4, the gas jet and ions entrained therein initially enter the inlet end 140a of the ion guide 140 in the region bounded by the top and bottom inlet rods 158 and by the left and right PCB sidewalls 142a,b. One or more power supplies (not shown) can be configured to apply RF electric potentials to the inlet rods 158 and electrode (1) of the PCB sidewalls 142 so as to generate a quadrupole RF field to provide radial focusing of the ions. As will be appreciated by a person skilled in the art, for example, by applying an RF potential of a first phase (i.e., Phase B) to the inlet rods 158 and an RF electric potential of the opposite phase (i.e., Phase A which can have the same magnitude but 180° out of phase with Phase B) to electrode (1) (of both PCB sidewalls 142a,b, though 142b is not shown), the quadrupole RF field in the inlet region can be effective to maintain the ions entrained in the gas flow substantially along the central axis to prevent ions from being lost against the walls of the ion guide 140 upon entry.

That is, as schematically depicted at cross-section (1) of FIG. 5, the RF field generated by the inlet rods 158 and electrodes (1) of PCB sidewalls 142a,b provides a radially directed force towards the central axis (A) as the ions enter the inlet region.

As shown in FIG. 4, electrode (4) can have the same RF potential of Phase A applied thereto as that of electrode (1), while its mirror electrode (5) on the other side of the central axis (A) can have the RF potential of Phase A supplemented with a DC potential (e.g., a DC potential of the same polarity of the ions of interest, positive in the case of a cation). In this manner, as shown in cross-section (2) of FIG. 5, the proximally-extending portion of electrode (5) generates a repulsive DC force that is effective to impel ions exiting the inlet region upward away from the central axis (A). As shown in FIG. 4, the RF potential of Phase B can also be applied to the top and bottom opposed wall electrodes 144a,b (as well as electrode (2) of the PCB sidewall 142) such that the deflected ions will not strike the upper wall electrode 142a, but rather attempt to settle in a potential well offset from the central axis (A) formed by the superposition of the RF focusing field and DC repulsive force at this axial position. (It will be appreciated that the RF signal applied to electrodes (2) and (3) of the sidewalls 142 can supplement the field generated by the wall electrodes 144a,b, respectively.) It will also be appreciated by the person skilled in the art, that as the ions continue to traverse the ion guide 140 downstream due to the axial velocity imparted thereto by the gas flow, the changing fields generated by the shape and/or configuration of the electrodes and the electric potentials applied thereto can be manipulated in accordance with the present teachings such that the potential minima at each axial position selectively impels the movement of the ions.

For example, as the ions are transmitted past the proximal end of electrode (6), to which an RF potential of Phase B and a repulsive DC potential is applied, the ions are further driven from the central axis (A) under the influence of the repulsive DC force generated by electrodes (5) and (6), which as shown in cross-section 3 is superimposed on the substantially quadrupole RF field generated by the RF potential of Phase A applied to the PCB sidewalls 142 and the RF potential of Phase B applied to the upper wall electrode 144a and electrode (6). As such, the ions are maintained away from the central axis (A) and outside of the gas jet, which can largely maintain its barrel shock structure as it traverses the ion guide 140. As discussed otherwise herein, with the ions thereby extracted out of the gas flow, the gas jet can then be directed out of the ion guide 140, for example, through the exit window(s) 148 in the PCB sidewalls 142a,b.

As will be appreciated by a person skilled in the art, the obstruction 152 can also have an electric potential applied thereto so as to control the movement of the ions as they are transmitted through the ion guide 140. By way of example, the obstruction 152 can be coupled to a power source such that an RF potential can be applied to the obstruction 152 to focus the ions that are being diverted therearound. By way of example, as shown at cross-section 4 of FIG. 5, an RF potential of Phase B can be applied to the obstruction 152 such that the ions are substantially focused in the center of the channel extending between the obstruction 152 and the upper wall electrode 144a, which at this region is extending substantially parallel to the central axis (A).

After passing the obstruction 152 under the influence of their initial axial momentum from the gas flow, the ions are directed back toward the central axis (A) due to the sharp turn toward the central axis (A) of the wall electrode 144a. That is, the RF potential of Phase B applied to the wall electrode 144a prevents the ions from striking the electrode 144a such that the trajectory of the ions is pushed downward as the ions move toward the outlet end 142b, as shown for example in cross-section 5 of FIG. 5. The same RF potential on the wall electrode 144b likewise prevents the ions from being deflected too far beyond the central axis (A). Rather, the combination of the RF potential of Phase A applied to electrode (7) of the PCB sidewalls 142 and the RF potential of Phase B applied to the wall electrodes 144a,b can be effective to focus the ions into a coherent ion beam substantially on the central axis (A), as shown in cross-section 6 of FIG. 5. Moreover, as noted above with reference to FIG. 2, the ion guide 140 can additionally include outlet electrodes 178 disposed downstream of the obstruction 152 to which an RF signal can be applied to the electrodes 178 so as to generate a focusing quadrupole RF field in conjunction with the converging wall electrodes 144 to tightly focus the ions for transmission through the outlet aperture 120.

It will be appreciated in light of the present teachings, that various parameters including the size, shape, and pattern of the electrodes and the potentials applied thereto can be selected so as to optimize transmission of the ions through the ion guide in accordance with the present teachings. A pump (not shown) can be operated to evacuate the vacuum chamber 114 containing the ion guide 140 to an appropriate sub-atmospheric pressure. By way of example, the pump can be selected to operate at a speed of about 3-13 m³/hr to generate a sub-atmospheric pressure within the vacuum chamber in the range from about 1 Torr to about 20 Torr (e.g., from about 2-3 Torr, about 2.4 Torr). The inlet orifice 118 can have a variety of sizes, for example, the inlet orifice can have a diameter of about 0.5 mm to about 1.5 mm. The supersonic gas flow in which the ions are entrained can enter the inlet end 140a of the ion guide 140 along the central axis (A) and between the PCB sidewalls 142 and the inlet rods 158, each having an inner surface spaced from the central axis by about 5 mm. The wall electrodes 144 can be of a variety of sizes and shapes, though in the embodiment depicted in FIG. 1, for example, the wall electrodes 144 can have an inner surface having a maximum distance from the central axis of about 15 mm, with the inner surface of the PCB sidewalls maintaining the separation from the central axis (A) at about 5 mm substantially along their entire length. The obstruction 52, which can be disposed on the central axis (A) and have one or more deflecting surfaces 152a angled at about 30 degrees relative to the central axis (A), can have a width of about 10 mm to about 15 mm orthogonal to the central axis (A). In the exemplary embodiment depicted in FIG. 1, the obstruction 52 can be centered about the central axis (A) and positioned in a range of about 30 to 100 mm (e.g., about 50 mm from the inlet end 140a). The ions that are deflected and focused by the ion guide 140 are transmitted through the exit aperture 120, which can have a diameter of about 1 mm to about 3 mm.

The RF and DC potentials applied to various portions of the ion guide 140 can be selected in accordance with the present teachings to provide for the extraction of ions of interest from a gas stream and their re-focusing for transmission to a downstream mass analyzer. By way of non-limiting example, the DC potential applied to electrode (5) of the PCB sidewall for deflecting the ions from the central axis (A) can be in the range from about +1V to about +30 V, while the RF potentials can be in a range of about 10 V₀₋ₚ to about 150 V₀₋ₚ at a frequency in a range from about 500 kHz to about 3 MHz.

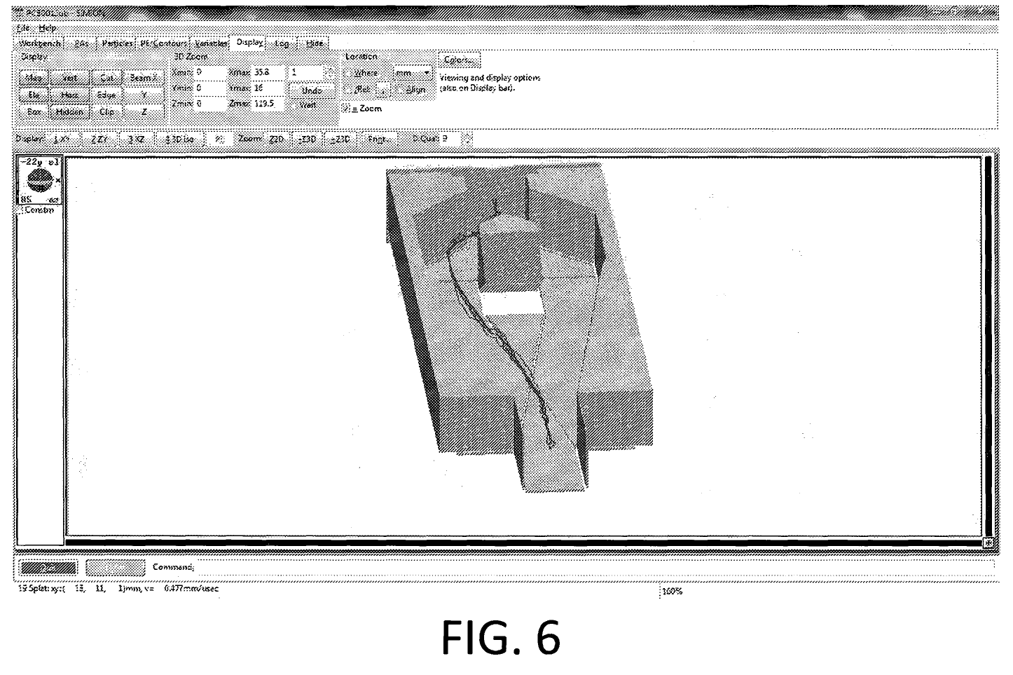

Thus, as shown in FIG. 6, which depicts a simulation of the movement of ions of various m!z through an exemplary prototype of the ion guide 140 of FIG. 1, ions that enter the ion guide 140 in a gas stream are initially focused along the central axis (A), deflected out of the gas stream toward the upper wall electrode 144a and around the obstruction 152 (which can divert the gas flow out of the enclosure via the exit window 148), and re-focused downstream of the obstruction for transmission as a coherent ion beam.

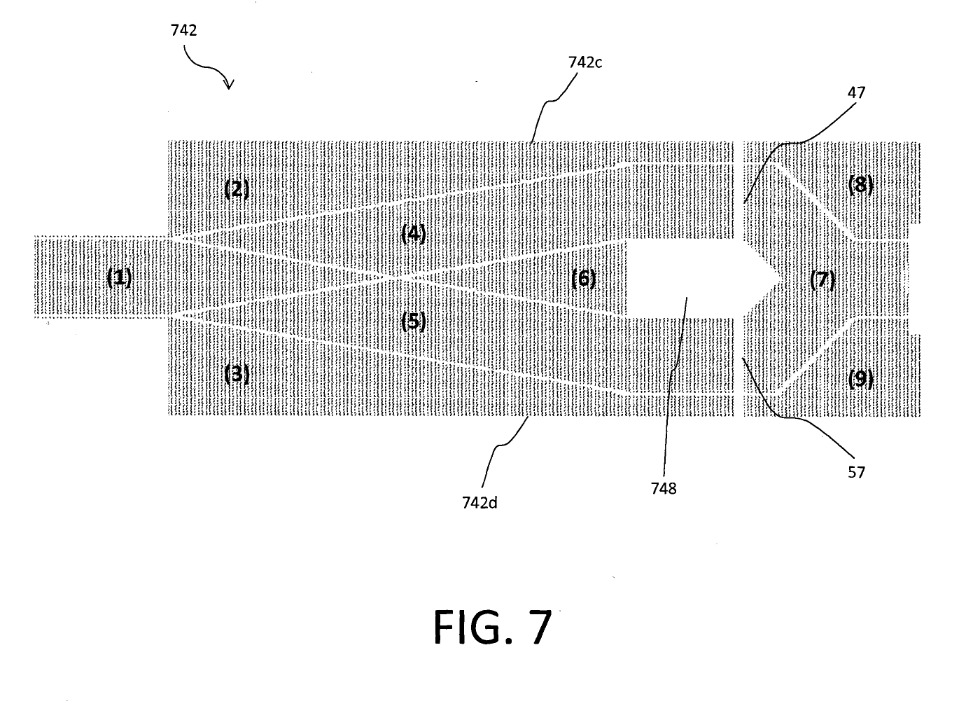

With reference now to FIGS. 7-9, another exemplary ion guide 740 is schematically depicted. The ion guide 740 is similar to that described above with reference to FIGS. 1-6, in that it includes inlet rods 758, a PCB sidewall 742 having a plurality of electrode regions separated by non-conductive portions, and wall electrodes 744 extending between the PCB sidewalls 742.

With reference to FIG. 7, the exemplary PCB sidewall 742 in accordance with various aspects of the present teaching is schematically depicted. The electrode regions of the PCB sidewall 742 are substantially similar to those discussed above with reference to the exemplary PCB sidewall 142 depicted in FIG. 3, but differ in that uppermost and lowermost electrodes (electrodes (2) and (3) of FIG. 3) are divided into two electrodes each such that the exemplary PCB sidewall 742 comprises nine electrode regions. For example, as shown in FIG. 7, the non-conductive portions 47, 57 do not end at the lower and upper edges of electrodes (2) and (3) as in FIG. 3, but rather extend substantially perpendicular relative to the longitudinal axis (B) of the PCB sidewall 742 all the way from the window 748 to the upper and lower edges 742c,742d of the PCB sidewall 742. As such, different electrical signals can be applied to each of electrode (3) and electrode (9), for example, as discussed below.

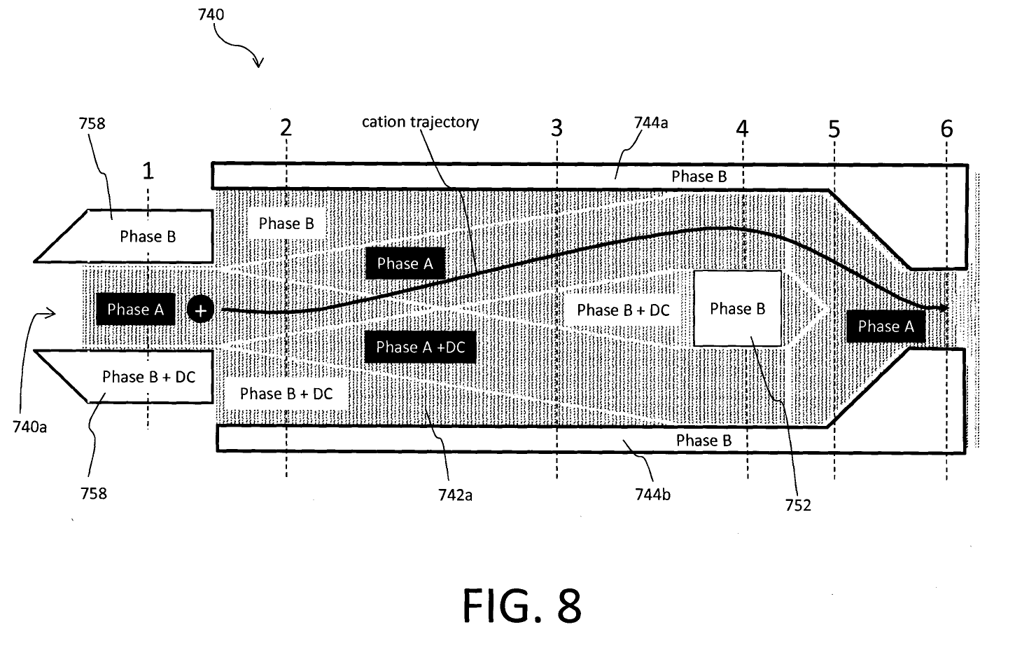

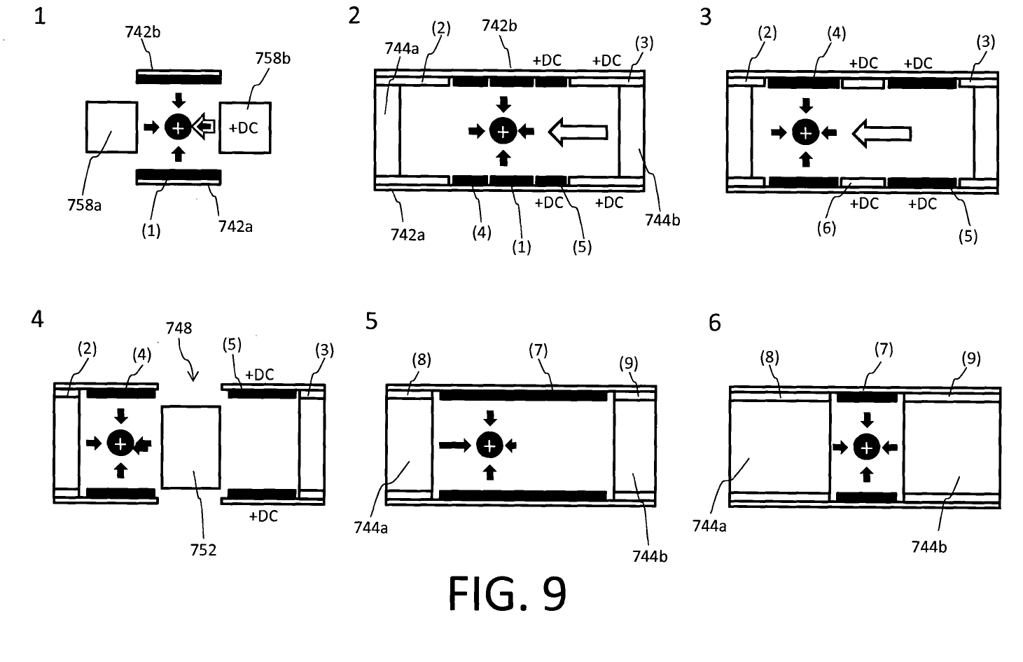

With reference now to FIG. 8, the wall electrodes 744 also differ from those described above in that rather than corresponding to the shape of electrodes (2) and (3) of the PCB sidewall 742, the distance between the inner surface of the wall electrodes 744 remains substantially constant along their upstream ends. That is, whereas the inner surface of the wall electrodes 144 are initially aligned with the inlet rods 158 and diverge as the electrodes 144a,b extend downstream (i.e., the wall electrodes 744 corresponds with the path of travel of ions along electrode (4) of FIG. 3 so as to generate a stronger RF field to focus the ions deflected from the central axis (A) between the inlet end 740a and the obstruction 752), in the exemplary embodiment depicted in the FIG. 8 the distance between the wall electrodes 744 is substantially constant along their upstream ends, and varies only on their downstream ends. In this manner, ions may be more easily (e.g., more quickly) deflected away from the central axis (A) of ion guide 740, though the ions may also experience less upstream focusing along the center of electrode (4) due to the decreased strength of the RF field in this region (assuming an identical RF potential as that of FIG. 4). Regardless, as shown in the FIGS. 8 and 9, the distance between the wall electrodes 744 decreases at their downstream ends to promote the deflection of the ions back to the central axis (A) after passing the obstruction 752, as discussed otherwise herein.

Also as shown in FIGS. 8 and 9, the electrical potentials applied to the various regions of the PCB sidewall 742 can also differ relative to those described above with reference to FIGS. 4 and 5 so as to subject the ions traversing ion guide 740 to different electric fields relative to those experienced in ion guide 140. By way of example, as the gas jet and ions entrained therein initially enter the inlet end 740a of the ion guide 740 in the region bounded by the top and bottom inlet rods 758a,b and by the PCB sidewalls 742, a repulsive DC potential applied to the bottom inlet rod 758b impels the ions toward top rod 758a (and away from the central axis (A)), as shown in cross-section 1 of FIG. 8. Though the RF signal applied to the top inlet rod 758a may prevent the ions from contacting the top inlet rod 758a, it will be appreciated that the trajectory of the ions will immediately begin to diverge from the central axis (A).

Additionally, rather than an RF-only signal being applied to electrode (3) as in ion guide 140 of FIG. 4, electrode (3) of ion guide 740 can be supplemented with a DC potential (e.g., the same polarity and magnitude as that applied to electrode (5)) so as to generate an additional repulsive DC force effective to more quickly deflect ions exiting the inlet rods 758 upward and away from the central axis (A). (Because the non-conductive portion 57 of PCB sidewall 742 isolates the electrode (9) relative to electrode (3), an RF-only signal may nonetheless be applied to electrode (9) so as to generate a quadrupole RF field at the outlet end 740b of ion guide 740.) Further, as noted above, the increased distance between the wall electrodes 744 may provide a decreased counter RF-field strength at the inlet end such that ions may be more easily deflected from the central axis (A) by the additional repulsive DC force generated by electrode (3) of ion guide 740.

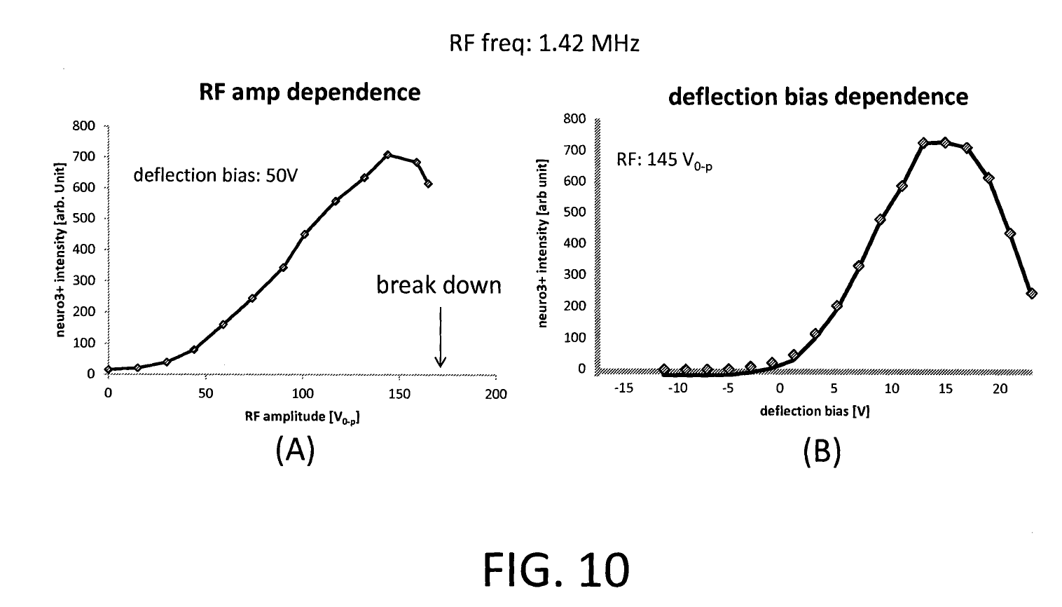

As demonstrated in FIGS. 7-9, it should be appreciated that ion guides in accordance with the present teachings can also be provided with various configurations of electrodes and/or signals so as to selectively control the movement of ions traversing therethrough. It will further be appreciated in light of the present teachings that the particular potentials applied to the various portions of the ion guide 740 (and indeed any ion guide in accordance with the present teachings) can be selected to optimize the transmission of ions therethrough, as will be discussed below with reference to FIG. 10.

FIG. 10 depicts exemplary data of the detected intensity of an ion of interest (neurotensin³⁺) transmitted through the ion guide 740 while varying the amplitude of the DC and RF potentials applied to the various portions of the PCB sidewall 742. With reference to FIG. 10A, the DC potential applied to electrodes (3), (5), and (6) of the PCB sidewall 742 is set to +50V, while the amplitude of the RF potential was ramped from 0 V₀₋ₚ, all at a frequency of 1.42 MHz. As depicted in FIG. 10A, the detected intensity of the ion of interest increased as the amplitude of the RF signal was increased until about 145 V₀₋, after which the detected intensity declines and then vanishes at a breakdown voltage of about 170 V₀₋ₚ. FIG. 10B, on the other hand, depicts the detected intensity of the ion of interest when the amplitude of the RF potential was maintained at 145 V₀₋ₚ (at a frequency of 1.42 MHz), while the DC potential applied to electrodes (3), (5), and (6) of the PCB sidewall 742 was ramped from about −10V to about +25V. As depicted in FIG. 10A, the ion of interest was not detected at negative DC values (i.e., the ions was deflected out of the gas stream but collided with the attractive electrodes in the case of a cation). However, the detected intensity of the ion of interest increases as the amplitude of the DC signal was increased up to about +10 V, after which the detected intensity declined (perhaps because of loss of the deflected ions on the walls of the ion guide). For example, it will be appreciated in light of the present teachings that ions having a smaller m/z ratio would be generally deflected from the central axis (i.e., out of the gas flow) earlier or with greater velocity than those ions having a larger m/z ratio. As such, and without being bound to any particular theory, it may be necessary to limit and/or adjust the DC deflection voltage to ensure that the ions of lower m/z and/or higher m/z are adequately captured depending on the application. Based on these plots, it should be appreciated that the various signals applied to the portions of the ion guides in accordance with the present teachings can be altered so as to tune the ion guides for maximum transmission of the ions of interest. That is, a user can select parameters such as the RF and DC signals applied to the electrodes of the PCB sidewalls to optimize the deflected trajectory of the ions of interest out of the gas jet and around the obstruction. As such, the control signals provided to ion guide 740 (e.g., the amplitude of the RF and DC signal applied to various electrodes) may be adjustable to enable more ions to be isolated from the gas flow, thereby potentially improving sensitivity of the device.

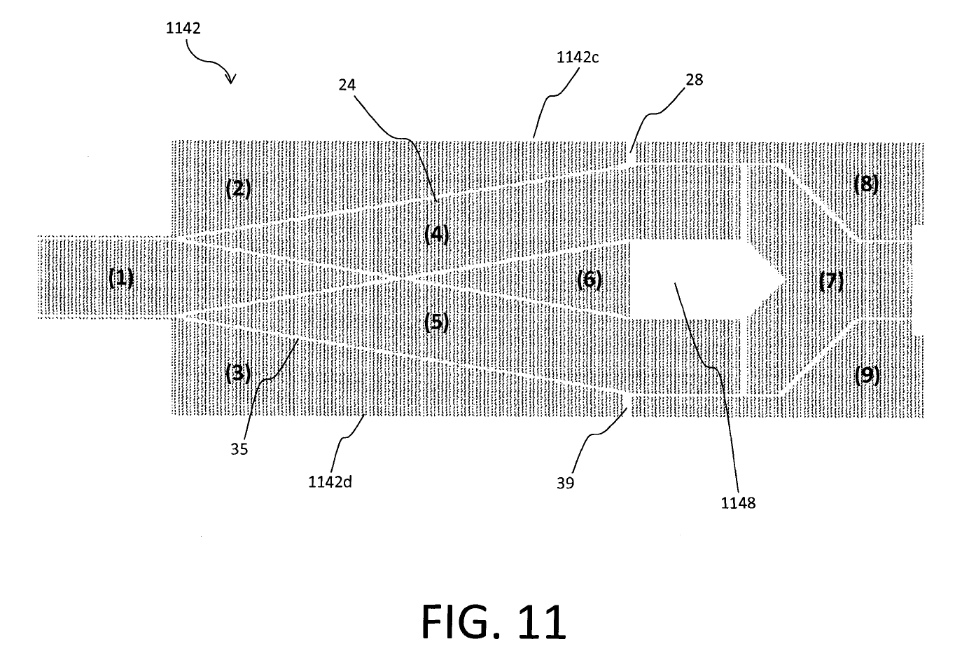

With reference now to FIGS. 11-13, another exemplary ion guide 1140 is schematically depicted. Like the ion guides 140 and 740 describes above, the ion guide 1140 includes inlet rods 1158, PCB sidewalls 1142 having a plurality of electrode regions separated by non-conductive portions, and wall electrodes 1144 extending between the PCB sidewalls 1142. Moreover, with specific reference to FIG. 11, the electrode regions of the PCB sidewall 1142 are substantially similar to those discussed above with reference to the exemplary PCB sidewall 142 depicted in FIG. 3, but differs in that uppermost and lowermost electrodes (electrodes (2) and (3) of FIG. 3) are divided into two electrodes each such that the exemplary PCB sidewall 1142 comprises nine electrode regions. For example, as shown in FIG. 10, a non-conductive portion 28, which extends substantially perpendicular relative to the longitudinal axis (B) of the PCB sidewall 1142 between the upper edge 1146c of the PCB sidewall and the non-conductive portion 24 at the proximal edge of the window 1148, defines the distal edge of electrode (2) and the proximal edge of electrode (8) such that different electrical signals can be applied to each of electrode (2) and electrode (8) as discussed below. Similarly, a non-conductive portion 39, which extends substantially perpendicular relative to the longitudinal axis (B) of the PCB sidewall 1142 between the lower edge 1146d of the PCB sidewall and the non-conductive portion 35 at the proximal edge of window 1148, defines the distal edge of electrode (3) and the proximal edge of electrode (9) such that different electrical signals can also be applied to each of electrode (3) and electrode (9).

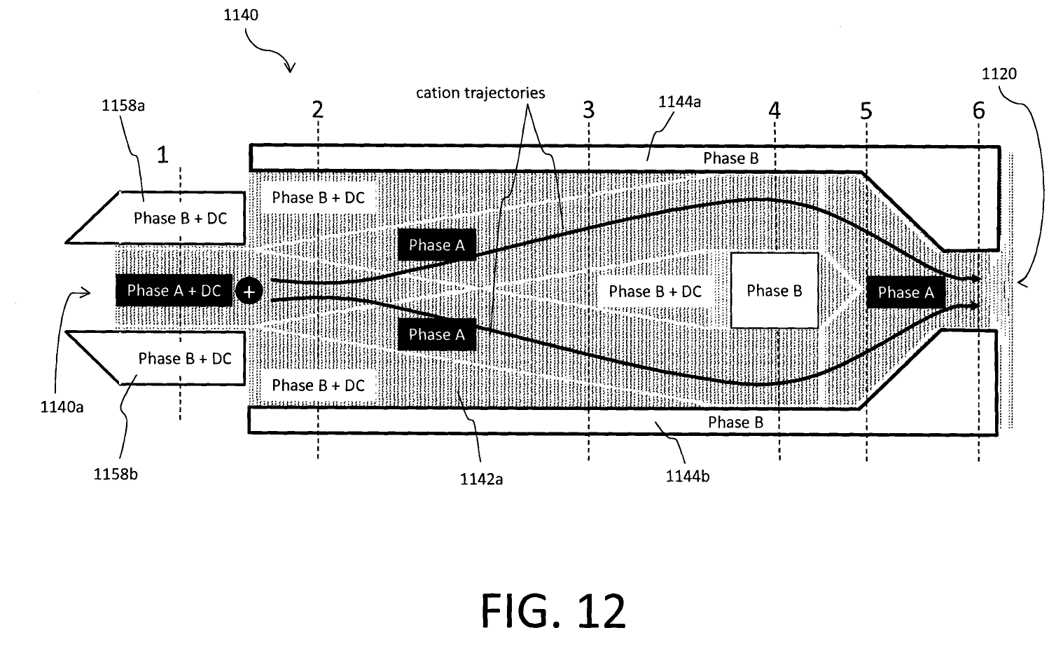

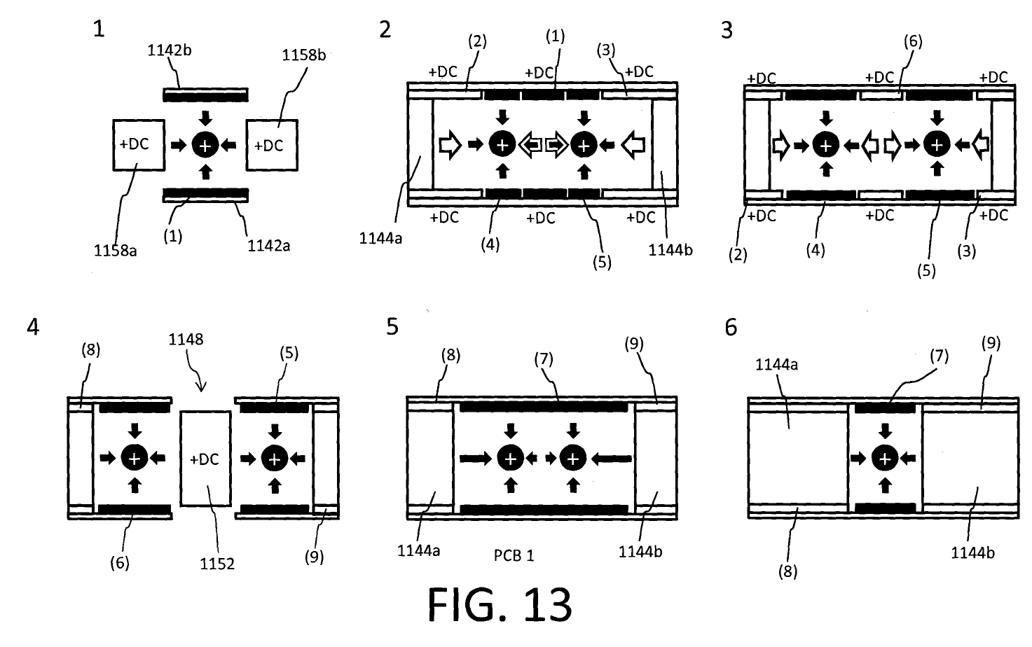

With reference now to FIGS. 12 and 13, the electrical potentials applied to the various regions of the PCB sidewall 1142 can also differ relative to those described above so as to subject the ions traversing ion guide 1140 to different electric fields relative to those experienced in ion guides 140 and 740. By way of example, as the gas jet and ions entrained therein initially enter the inlet end 1140a of the ion guide 1140, an RF signal and a repulsive DC potential applied to the top and bottom inlet rods 1158a,b and the PCB sidewalls 1142 can generate a radially directed force for focusing the ions along the central axis. (The net effect of the DC fields will also focus the ions as the repulsion would be stronger for ions that enter the inlet end 1140a farther off-axis).

Additionally, rather than an RF-only signal being applied to electrodes (2) and (3) as in ion guide 140 of FIG. 4, electrodes (2) and (3) of ion guide 1140 can be supplemented with a repulsive DC potential. In light of the DC field generated along the central axis (A) by electrode (1), ions transmitted through the inlet rods are drawn towards either electrode (4) or (5) to which an RF-only signal is applied (e.g., depending their location relative to the central axis (A)), as shown for example in cross-section 2 of FIG. 13. As the ions continue downstream, the DC potential applied to electrode (6) acts to further diverge the split groups of ions and focus these ions along the center of electrodes (4) and (5). Downstream of the proximal end of the obstruction 1152, the DC field vanishes such that the ions in each channel are subjected to a substantially quadrupole RF field (e.g., generated by the RF signals of Phase B applied to the obstruction 152 and the wall electrode 1144a (supplemented by the RF signal on electrode (8)) on one hand and the RF signals of Phase A applied to electrodes (4) and (5) on the other), as shown for example at cross-section 4 of FIG. 13.

After passing the obstruction 1152, the ions in each channel are directed back toward the central axis (A) due to RF potential (e.g., of Phase B) applied to the converging wall electrodes and can be focused by a focusing quadrupole RF field for transmission through the outlet aperture 1120. With at least a portion of the gas flow removed from the ion guide 1140, the ion guide 1140 may enable the focusing of the ions into a coherent ion beam for downstream transmission.

Though the initial axial velocity of ions entering the ion guides discussed herein can in some aspects be sufficient to transport the ions along the length of the ion guide once removed from the gas jet, it will be appreciated that the axial motion of the ions can be supplemented, for example, by generating an axial DC field within the ion guide. By way of example, the opposed wall electrodes 1144 could be segmented along their length with various DC voltages applied thereto so as to generate a DC “ladder” to accelerate or slow ions' axial movement as they traverse the ion guide 1140.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. An ion guide, comprising:
an enclosure comprising at least two opposed sidewalls extending longitudinally along a central axis from a proximal inlet end to a distal outlet end, the proximal inlet end being configured to receive a plurality of ions entrained in a gas flow through an inlet orifice disposed on the central axis; and
an obstruction disposed within said enclosure between the proximal and distal ends, said obstruction deflecting at least a portion of the gas flow away from said central axis of the enclosure,
wherein each of said opposed sidewalls comprises a plurality of electrodes to which RF and DC electric voltages are applied so as to generate an electric field for deflecting said entrained ions away from the central axis of the enclosure proximal to said obstruction and at least one electrode to which a RF electric potential is applied for focusing said deflected ions toward the central axis distal to said obstruction.

2. The ion guide of claim 1, wherein at least one of the opposed sidewalls defines a window through which at least a portion of the gas flow can exit the enclosure.

3. The ion guide of claim 1, wherein the enclosure is further defined by opposed wall electrodes disposed between the opposed sidewalls and wherein the opposed wall electrodes are offset relative to said central axis such that they are outside the gas flow.

4. The ion guide of claim 3, wherein a distance between the opposed wall electrodes varies along at least a portion of their length.

5. The ion guide of claim 3, wherein an inner surface of the opposed wall electrodes are non-parallel with the central axis along at least a portion of their length along the central axis.

6. The ion guide of claim 1, wherein the plurality of electrodes of the opposed sidewalls comprises a plurality of polygonal conductive surfaces.

7. The ion guide of claim 1, wherein the opposed sidewalls comprise printed circuit boards extending along a longitudinal axis from a proximal end to a distal end.

8. The ion guide of claim 7, wherein the plurality of electrodes comprise conductive surfaces separated from adjacent electrodes by non-conductive portions of the printed circuit boards.

9. The ion guide of claim 1, wherein the opposed sidewalls further comprise a plurality of electrodes to which only an RF signal is applied.

10. The ion guide of claim 1, wherein the plurality of electrodes are configured to define a potential minimum substantially outside of said gas flow.

11. The ion guide of claim 1, wherein an electric field at the inlet end and outlet end are substantially quadrupole RF fields.

12. The ion guide of claim 11, further comprising a plurality of rods at the outlet end configured to generate a quadrupole RF focusing field.

13. A method of transmitting ions, comprising:
receiving a plurality of ions entrained in a gas flow at an inlet end of an enclosure, said enclosure extending longitudinally around a central axis from the proximal inlet end to a distal outlet end, said enclosure comprising at least two opposed sidewalls extending longitudinally along the central axis with each of the opposed sidewalls having a plurality of electrodes;
applying RF and DC electric potentials to at least an opposed pair of the plurality of electrodes of the opposed sidewalls so as to generate an electric field in the enclosure for deflecting at least a portion of said entrained ions away from the central axis;
deflecting at least a portion of the gas flow to an opening for exiting the enclosure subsequent to deflecting said deflected ions; and
focusing said deflected ions for transmission to a downstream mass analyzer.

14. The method of claim 13, wherein at least one of the opposed sidewalls defines a window through which at least a portion of the gas flow is removed from the enclosure.

15. The method of claim 13, wherein the enclosure is further defined by opposed wall electrodes disposed between the opposed sidewalls, and wherein the opposed wall electrodes are offset relative to said central axis such that they are outside the gas flow.

16. The method of claim 15, wherein the plurality of electrodes are configured to define a potential minimum substantially along the opposed wall electrodes.

17. The method of claim 16, wherein a distance between the opposed wall electrodes varies along at least a portion of their length.

18. The method of claim 13, wherein the opposed sidewalls comprise printed circuit boards, each defining a plurality of substantially planar conductive surfaces separated by non-conductive portions.

19. The method of claim 18, wherein at least some of the non-conductive portions are not perpendicular to one another.

20. The method of claim 19, wherein at least some of the non-conductive portions are not parallel or perpendicular to the longitudinal axis of the printed circuit board.
